(19) United States
(12) Patent Application Publication
(10) Pub. No.: US 2011/0001767 A1
(43) Pub. Date: Jan. 6, 2011

(54) IMAGE DISPLAY DEVICE

(75) Inventors: Kenta KAJIYAMA, Mobara (JP); Hiroshi Kageyama, Hachioji (JP); Takeshi Izumida, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Displays, Ltd.; Canon Kabushiki Kaisha

(21) Appl. No.: 12/828,834

(22) Filed: Jul. 1, 2010

(30) Foreign Application Priority Data
Jul. 3, 2009 (JP) 2009-159201

(51) Int. Cl. G09G 5/10

(52) U.S. Cl. 345/691; 345/77

(57) ABSTRACT

An image display device includes signal lines; a video signal generating means which generates a video signal based on gray level information from the outside; a compensation signal generating means which generates a compensation signal based on the gray level information; a selecting means which alternately supplies the video signal and the compensation signal to the signal lines; and a plurality of pixel circuits which are connected to the signal lines. The compensation signal generating means generates the compensation signal based on the gray level information such that the larger the time integration of the potential of the video signal is, the smaller the time integration of the potential of the compensation signal is.

### CROSS-REFERENCE TO RELATED APPLICATION

The present application claims priority from Japanese application JP2009-159201 filed on Jul. 3, 2009, the content of which is hereby incorporated by reference into this application.

### BACKGROUND OF THE INVENTION

1. Field of the Invention

The present invention relates to an image display device, and more particularly to an image display device which uses a flat display panel.

2. Description of the Related Art

Image display devices which use a flat display panel such as a display device which uses organic electroluminescence elements (hereinafter referred to as “organic EL elements”), for example, have been remarkably developed.

FIG. 2 is a circuit diagram showing one example of the constitution of a pixel circuit included in an organic EL display device which is one of image display devices. Although not shown in FIG. 2 because FIG. 2 shows only one pixel circuit, a plurality of data signal lines DL and a plurality of power source lines PW extend in the vertical direction in the drawing and are arranged parallel to each other in the lateral direction respectively. Further, a plurality of select lines SEL, a plurality of auto zero control lines AZ and a plurality of lighting control lines AZB extend in the lateral direction in the drawing and are arranged parallel to each other in the vertical direction. A plurality of pixel circuits which correspond to the respective rows are connected to one data signal line DL. One pixel circuit includes an organic EL element LM which has one end thereof connected to a ground line, a p-channel drive transistor Q1 which has a source electrode thereof connected to the power source line PW, a lighting control switch Q4 which is arranged between a drain electrode of the drive transistor Q1 and the other end of the organic EL element and is controlled in response to a signal from the lighting control line AZB, an offset cancel capacitive element C1 which has one end thereof connected to a gate electrode of the drive transistor Q1, a pixel switch Q2 which is arranged between the data signal line DL and the offset cancel capacitive element C1 and is controlled in response to a signal from the select line SEL, a storage capacitive element C2 which is arranged between the source electrode and the gate electrode of the drive transistor Q1, and an auto zero switch Q3 which is arranged between the gate electrode and the drain electrode of the drive transistor Q1 and is controlled in response to a signal from the auto zero control line AZ.

To prevent the pixel circuit shown in FIG. 2 from being influenced by irregularities of a threshold voltage of the drive transistor, a control which cancels the threshold voltage of the drive transistor Q1 is performed. This control is referred to as “auto zero”. In this control, the lighting control switch Q4 is turned off firstly so as to stop emission of light from the organic EL element LM. Next, the pixel switch Q2, the auto zero switch Q3 and the lighting control switch Q4 of the pixel circuit are turned on. Accordingly, a charge held in the offset cancel capacitive element C1 and a charge held in the storage capacitive element C2 are reset. Next, when the lighting control switch Q4 is turned off, an electric current flows until a voltage value of a drain electrode of the drive transistor Q1 is lowered from a voltage value of the source electrode of the drive transistor Q1 by a threshold voltage Vth, that is, the drive transistor Q1 is turned off. Here, a voltage Vref of a reference signal is applied to the data signal line DL. Accordingly, the difference between the voltage Vref and the threshold voltage Vth of the drive transistor Q1 is inputted to the offset cancel capacitive element C1. Next, the auto zero switch Q3 is turned off so that a voltage Vdata of a video signal is applied to the data signal line DL. Accordingly, the potential difference corresponding to a change quantity from the voltage Vref to the voltage Vdata is generated in the storage capacitive element C2, and the organic EL element LM emits light corresponding to the potential difference.

FIG. 10 is a waveform diagram which shows the conventional relationship between the reference signal and the video signal supplied to the pixel circuit from the data signal line DL and the gray level of the pixel. With respect to four waveforms, the gray level is changed from black (dark gray level) to white (bright gray level) in a descending order. The reference signal is supplied during a period Tref in the drawing, and the video signal is supplied during a period Tdata in the drawing. The brighter the gray level becomes, the lower the potential of the video signal becomes. In the example shown in the drawing, when the gray level is white, the potential of the video signal is set lower than the potential of the reference signal. JP 2006-119242 A discloses the above-mentioned image display device of the related art.

In the image display device, it has been known that capacitive coupling is generated between a portion of the pixel circuit and the data signal line DL or the like. FIG. 11 shows an example of the capacitive coupling which is generated in the pixel circuit shown in FIG. 2. A coupling capacitance CC is generated between a node A and the data signal line DL. Due to the generation of the coupling capacitance CC, there may be a case where the gray level of the pixel to be displayed is changed so that smear occurs.

FIG. 12 shows an example of smear. The pixel circuits are arranged in a matrix array within a screen, and the data signal lines DL extend in the vertical direction. Writing of the video signal in the pixel circuits is performed sequentially from the top row. In the example shown in the drawing, the gray level of white is written in a center rectangular area, and gray level of gray is written in other areas. In writing the video signal in the pixel circuit in the center rectangular area within a region B, the video signal with low potential indicative of white is supplied to the data signal line DL. In the data signal lines DL on the rows above and below the data signal line DL, the pixel circuits are influenced by the video signal via the capacitive coupling CC so that the node A of the pixel circuit assumes the low potential. Accordingly, an electric current which flows in the organic EL element LM which constitutes one kind of the light emitting element from the drive transistor Q1 is increased and hence, the pixel exhibits the gray level larger than the original gray level above and below the center rectangular area during a period in which the gray level is written in the region B. This phenomenon is observed as smear.

### SUMMARY OF THE INVENTION

The present invention has been made under such circumstances, and it is an object of the present invention to provide an image display device which can reduce the occurrence of smear.

To simply explain the summary of typical inventions among inventions disclosed in this specification, they are as follows.

(1) According to one aspect of the present invention, there is provided an image display device which includes: signal lines; an acquisition means which acquires gray level information; a video signal generating means which generates a video signal based on the gray level information; a compensation signal generating means which generates a compensation signal (reference signal) based on the gray level information; a selecting means which alternately supplies the video signal and the compensation signal to the signal lines; and a plurality of pixel circuits; wherein each pixel circuit is connected to the signal line, the plurality of pixel circuits store the potential difference corresponding to the video signal sequentially, and display gray level corresponding to the stored potential difference, and the compensation signal generating means generates the compensation signal based on the gray level information such that the larger the time integration of the potential of the video signal during a period in which the video signal is supplied is, the smaller the time integration of the potential of the compensation signal during a period in which the compensation signal is supplied is.

(2) In the image display device having the constitution (1), the compensation signal generating means generates the compensation signal based on the gray level information such that the larger the potential of the video signal during a period in which the video signal is supplied to one of the plurality of pixel circuits is, the smaller the potential of the compensation signal during a period in which the compensation signal is supplied to one of the plurality of pixel circuits is.

(3) In the image display device having the constitution (1) or (2), each of the pixel circuits further includes a light emitting element which changes brightness in response to a quantity of an electric current, and the light emitting element emits light having gray level corresponding to the potential difference stored in each of the pixel circuits.

(4) In the image display device having the constitution (3), each of the pixel circuits further includes: a drive transistor which adjusts the quantity of electric current supplied to the light emitting element; a pixel switch which fetches a potential corresponding to the video signal or the compensation signal; and a storage capacitive element which stores a voltage which is obtained by adding a voltage corresponding to the potential difference between the video signal and the compensation signal to a threshold voltage of the drive transistor, and controls the quantity of electric current which the drive transistor supplies based on the stored voltage.

(5) In the image display device having the constitution (4), each of the pixel circuits further includes: an auto zero switch which is arranged between a gate electrode and a drain electrode of the drive transistor; a lighting control switch which is arranged between one end of the light emitting element and the drain electrode of the drive transistor; and a cancel capacitive element which is arranged between one end of the pixel switch and the gate electrode of the drive transistor, wherein a power source potential is supplied to a source electrode of the drive transistor, a predetermined reference potential is supplied to another end of the light emitting element, one end of the storage capacitive element is connected to the source electrode of the drive transistor, the other end of the storage capacitive element is connected to the gate electrode of the drive transistor, and the other end of the pixel switch is connected to the signal line.

(6) In the image display device having any one of the constitutions (1) to (5), the compensation signal generating means generates the compensation signal based on the gray level information such that a sum of the time integration of the potential of the video signal during a period in which the video signal is supplied and the time integration of the potential of the compensation signal during a period in which the compensation signal is supplied becomes equal to a product obtained by multiplying a sum of the period in which the video signal is supplied and the period in which the compensation signal is supplied by the predetermined potential.

(7) In the image display device having any one of the constitutions (1) to (5), the compensation signal generating means generates the compensation signal based on the gray level information such that an average of the potential of the video signal and the potential of the compensation signal becomes equal to a predetermined potential.

According to the present invention, it is possible to provide the image display device which reduces the occurrence of smear.

### BRIEF DESCRIPTION OF THE DRAWINGS

FIG. 1 is a view showing the schematic constitution of an organic EL display device according to an embodiment of the present invention;

FIG. 2 is a circuit diagram showing one example of the constitution of a pixel circuit;

FIG. 3 is a block diagram showing the constitution of a driver circuit;

FIG. 4 is a waveform diagram showing signals outputted to respective pixel circuits;

FIG. 5 is a waveform diagram showing the relationship between the gray level of a pixel and drive signals in the organic EL display device according to an embodiment of the present invention;

FIG. 6 is a waveform diagram showing a waveform of a drive signal;

FIG. 7 is a block diagram showing one constitution of a drive signal generating part;

FIG. 8 is a block diagram showing another constitution of the drive signal generating part;

FIG. 9 is a graph showing the relationship between gray level data and amplitude data;

FIG. 10 is a waveform diagram showing the conventional relationship between a reference signal and a video signal supplied to a pixel circuit from a data signal line and the gray level of a pixel;

FIG. 11 is a circuit diagram showing an example of a pixel circuit in which capacitive coupling is generated; and

FIG. 12 is a view showing an example of smear.

### DETAILED DESCRIPTION OF THE INVENTION

An embodiment of the present invention is explained in detail in conjunction with drawings with respect to a case where an image display device is constituted of an organic EL display device.

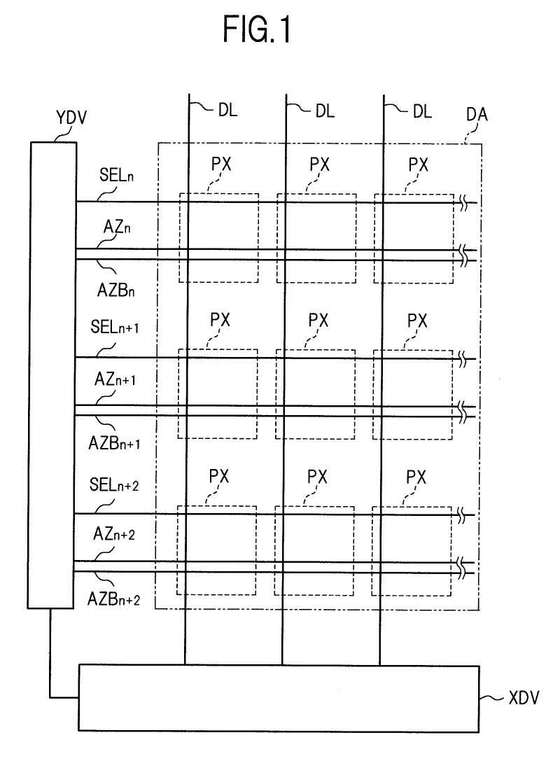

FIG. 1 is a view showing the schematic constitution of an organic EL display device according to the embodiment of the present invention. In a display region DA arranged at the center of the drawing, pixel circuits PX are arranged in a matrix array. Although only 9 pixel circuits PX (3 columns×3 rows) are shown in the display region DA in FIG. 1, in the actual circuit structure, a large number of pixel circuits PX are arranged in the horizontal direction and in the vertical direction for outputting images. For example, in case of a color display having the resolution of 480 (in the vertical direction)×640 (in the horizontal direction), pixel circuits PX of 480 rows×(640×3) columns are arranged.

A lighting control line AZB, an auto zero control line AZ and a select line SEL are connected to the plurality of pixel circuits PX which constitute a row of the matrix respectively, extend in the lateral direction in the drawing, and have respective left ends thereof in the drawing connected to a vertical scanning circuit YDV. Here, the lighting control line AZB, the auto zero control line AZ and the select line SEL which are connected to the pixel circuits PX on the k-th row counted from the top are particularly indicated by AZBₖ, AZₖ and SELₖ respectively. A plurality of data signal lines DL are connected to the plurality of pixel circuits PX which constitute the column of the matrix and extend in the vertical direction in the drawing, and the lower ends of the data signal lines DL are connected to a driver circuit XDV. Here, the organic EL display device includes a power source line PW not shown in the drawing for supplying a potential of a power source to the respective pixel circuits PX.

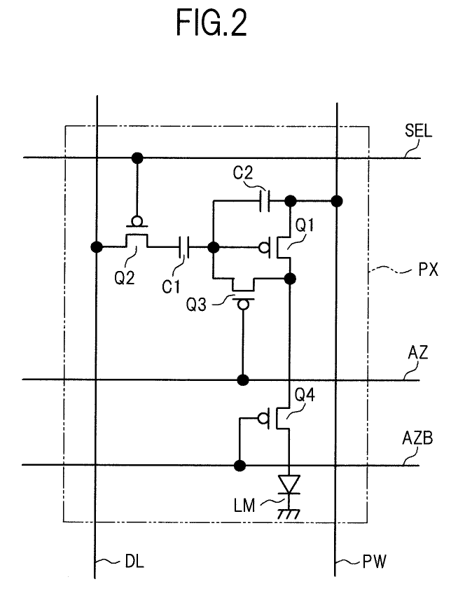

FIG. 2 is a circuit diagram showing one example of the constitution of the pixel circuit PX. The circuit constitution of the pixel circuit PX is explained hereinafter. The pixel circuit PX includes an organic EL element LM which has one end thereof connected to a ground line to which a ground potential is supplied, a p-channel drive transistor Q1 which has a source electrode thereof connected to the power source line PW, a lighting control switch Q4 which is provided between a drain electrode of the drive transistor Q1 and the other end of the organic EL element LM and is controlled in response to a signal from the lighting control line AZB, an offset cancel capacitive element C1 which has one end thereof connected to a gate electrode of the drive transistor Q1, a pixel switch Q2 which is provided between the data signal line DL and the offset cancel capacitive element C1 and is controlled in response to a signal from the select line SEL, a storage capacitive element C2 which is provided between the source electrode and the gate electrode of the drive transistor Q1, and an auto zero switch Q3 which is provided between the gate electrode and the drain electrode of the drive transistor Q1 and is controlled in response to a signal from the auto zero control line AZ. Here, the pixel switch Q2, the auto zero switch Q3 and the lighting control switch Q4 are constituted of a p-channel thin film transistor. A gate electrode of the pixel switch Q2 is connected to the select line SEL, a gate electrode of the auto zero switch Q3 is connected to the auto zero control line AZ, and a gate electrode of the lighting control switch Q4 is connected to the lighting control line AZB. The circuit constitution explained above is substantially equal to the circuit constitution of the related art.

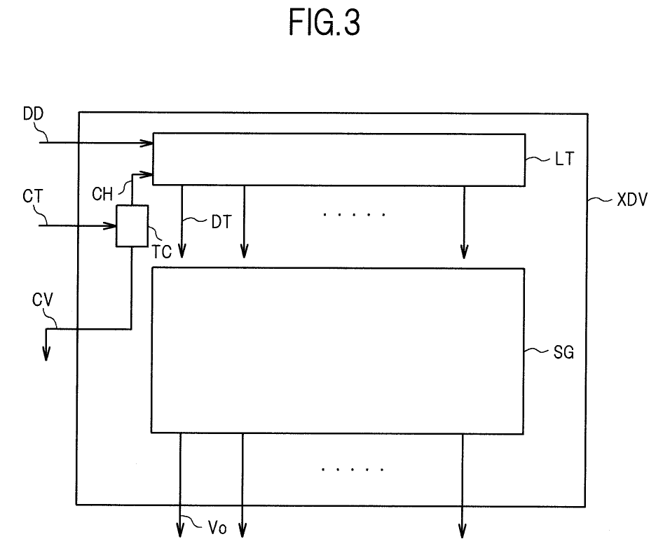

FIG. 3 is a block diagram showing the constitution of the driver circuit XDV. The driver circuit XDV is constituted of a latch circuit LT, a timing control circuit TC and a drive signal generating part SG. The timing control circuit TC acquires a control signal CT from the outside and generates a horizontal synchronizing signal CH and a vertical synchronizing signal CV in response to the control signal CT. The latch circuit LT acquires display data DD for one row from the outside, decomposes the display data DD amounting to one row into gray level data DT for respective pixels in response to the horizontal synchronizing signal CH, and holds the gray level data DT therein. The latch circuit LT collects the gray level data DT for one row and outputs the gray level data DT to the drive signal generating part SG. The drive signal generating part SG generates a drive signal Vo for allowing the pixel circuits corresponding to the row to store the gray level of the pixel based on the gray level data DT, and outputs the drive signal Vo to the data signal lines DL corresponding to respective columns of the matrix of the pixels. Here, the vertical synchronizing signal CV is supplied to the vertical scanning circuit YDV.

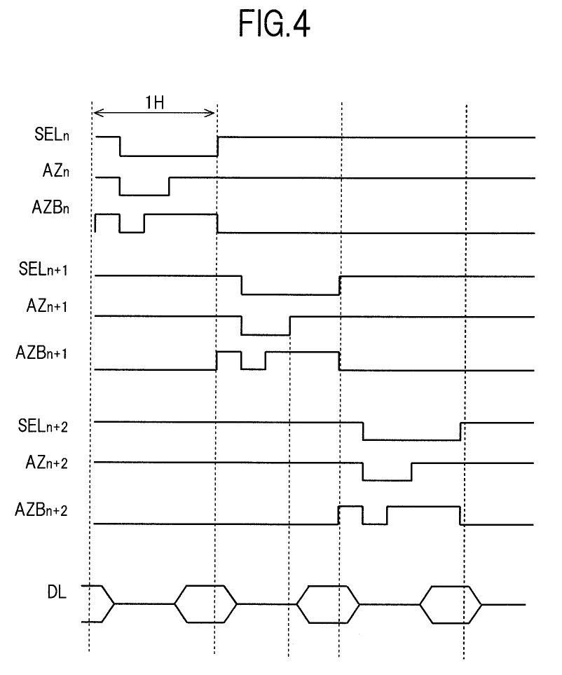

Next, signals which are outputted to the respective pixel circuits PX from the vertical scanning circuit YDV and the driver circuit XDV and the manner of operation of the pixel circuits PX in response to the signals are explained. FIG. 4 is a waveform diagram showing signals outputted to the respective pixel circuits PX. As counted from the top, waveforms of potentials which are supplied to the select line SELₙ, the auto zero control line AZₙ, the lighting control line AZBₙ, the select line SELₙ₊₁, the auto zero control line AZₙ₊₁, the lighting control line AZBₙ₊₁, and the select line SELₙ₊₂, the auto zero control line AZₙ₊₂, the lighting control line AZBₙ₊₂, and one data signal line DL are shown in this order. Here, the pixel switch Q2 which is connected to the select line SEL, the auto zero switch Q3 which is connected to the auto zero control line AZ, and the lighting control switch Q4 which is connected to the lighting control line AZB are constituted of a pMOS and hence, in the waveform diagram showing the select line SEL, the auto zero control line AZ and the lighting control line AZB, a period during which a potential is low (on a lower side) indicates a state where the connected switch is turned on, and a period during which the potential is high (on an upper side) indicates a state where the connected switch is turned off. With respect to the waveform of the data signal line DL, a potential Vdata of a video signal is supplied during a period where the waveform of the data signal line DL has a certain amplitude, and a potential Vref of a reference signal (or referred to as a compensation signal) is supplied during a period where the waveform of the data signal line DL has no such an amplitude.

An operation to store the video signal Vdata in the pixel circuits PX is performed for every row. The row on which the video signal Vdata is written in the pixel circuits PX is sequentially selected by the select line SEL. The video signal Vdata is supplied to the data signal line DL corresponding to a certain column of the pixel circuits PX from the driver circuit XDV, and the video signal Vdata is written in the pixel circuits PX on the row selected by the select line SEL. When the writing is finished, the pixel circuit PX emits light with intensity corresponding to the written video signal. This operation is performed with respect to the respective rows.

The manner of operation with respect to the pixel circuits PX on the n-th row is specifically explained. In FIG. 4, a period (1H) during which the writing operation is performed with respect to the pixel circuits PX on each row corresponds to the so-called horizontal scanning period. Firstly, the potential of the lighting control line AZBₙ assumes the OFF potential so that the emission of light from the organic EL element LM is stopped. Next, the select line SELₙ, the auto zero control line AZₙ and the lighting control line AZBₙ assume the ON potential and hence, the pixel switch Q2, the auto zero switch Q3 and the lighting control switch Q4 of the pixel circuit on the n-th row are turned on. Accordingly, a charge held in the offset cancel capacitive element C1 and a charge held in the storage capacitive element C2 are reset. Next, when the potential of the lighting control line AZBₙ is elevated so that the lighting control switch Q4 is turned off, an electric current flows until the drain end of the drive transistor Q1 assumes a potential lowered from the source voltage by a threshold voltage Vth, that is, until the drive transistor Q1 is turned off. Here, the reference signal Vref is applied to the data signal line DL. At this timing, the reference signal Vref and the potential corresponding to the threshold voltage Vth of the drive transistor Q1 are inputted to the offset cancel capacitive element C1. Next, the potential of the auto zero control line AZ is elevated so that the auto zero switch Q3 is turned off and the video signal Vdata is applied to the data signal line DL. Then, a potential corresponding to a change quantity (Vdata-Vref) of the data signal line DL is applied to the gate electrode of the drive transistor Q1. This voltage is, when the potential of the select line SELₙ is elevated so that the pixel switch Q2 is turned off, stored in the storage capacitive element C2. Thereafter, the lighting control switch Q4 is turned on so that the writing of the video signal in the pixel is completed whereby the organic EL element LM emits light with the gray level corresponding to Vdata-Vref. This writing operation is also applied to other rows such as the n+1 row and rows which follow the n+1 row. The voltage which the storage capacitive element C2 stores in the writing operation becomes a voltage obtained by adding a voltage corresponding to a change quantity of the data signal line DL to the threshold voltage of the drive transistor Q1 and hence, it is possible to suppress a change in quantity of an electric current which flows in the organic EL element LM based on the threshold voltage of the drive transistor Q1. This writing operation is referred to as “auto zero”.

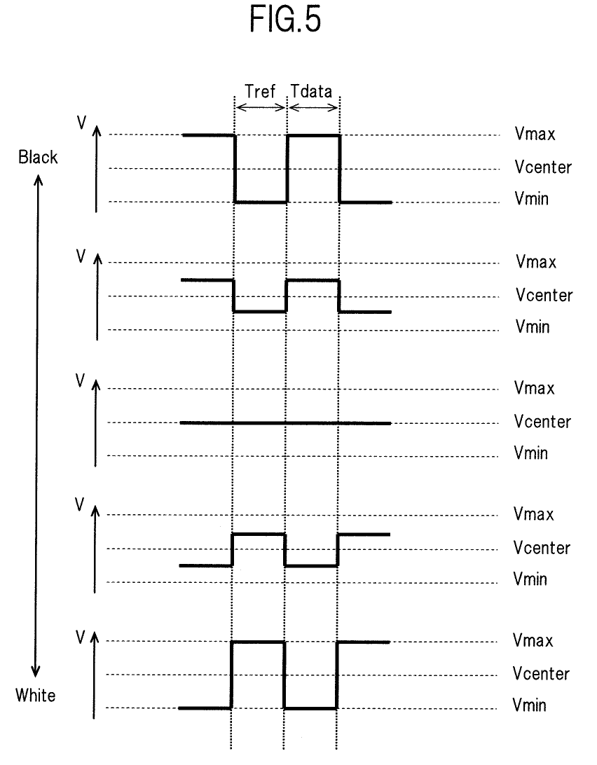

FIG. 5 is a waveform diagram showing the relationship between the gray level of the pixel and drive signals Vo in the organic EL display device according to the embodiment of the present invention. The gray level of the pixel is changed from black (gray level of dark) to white (gray level of bright) in the descending order from the uppermost waveform to the lowermost waveform. The video signal and the reference signal are alternately supplied to the data signal line DL. Here, a period during which the reference signal is supplied to the pixel circuit PX on a certain row is described as a reference signal supply period Tref, and a period during which the video signal is supplied to the pixel circuit PX on the certain row is described as a video signal supply period Tdata. In this embodiment, during a period where the voltage of brightness based on the gray level data is stored in the pixel circuit PX on the certain row, not only Vdata but also Vref is made variable. That is, Vref and Vdata are set such that the average of potential of the drive signal with time becomes a preset center potential Vcenter. As described previously, the organic EL element LM emits light in response to the change quantity (Vdata-Vref) of the potential applied to the data signal line DL and hence, there arises no problem even when the potential of the reference signal is changed. Here, since the drive transistor Q1 is a pMOS, the larger Vdata-Vref becomes, the darker the gray level of the pixel which the pixel circuit PX displays becomes. Further, in this embodiment, (Vdata-Vref) can be changed within a range from—(Vmax-Vmin) to (Vmax-Vmin).

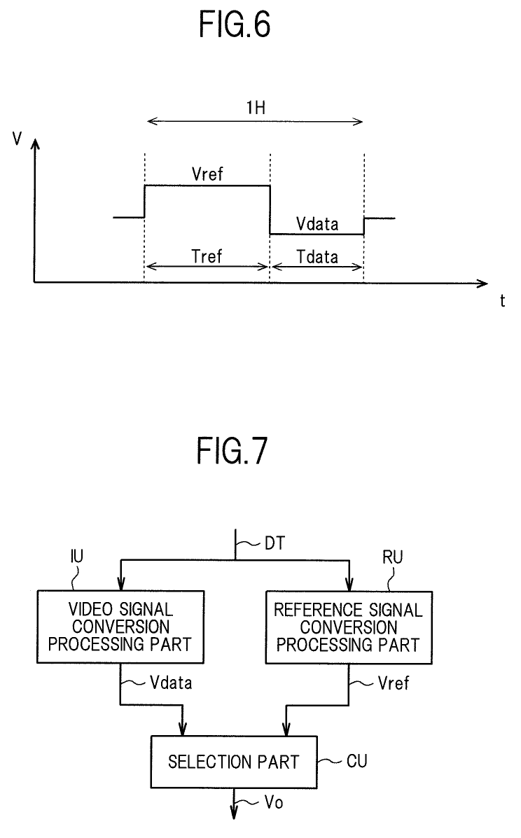

FIG. 6 is a waveform diagram showing a waveform of the drive signal. A period (1H) corresponding to a horizontal scanning period is divided into the reference signal supply period Tref and the video signal supply period Tdata. The potential of the reference signal during the reference signal supply period Tref is Vref, and the potential of the video signal during the video signal supply period Tdata is Vdata. The condition for setting the average of the potential of the drive signal with time to the center potential Vcenter is that a value which is obtained by adding the time integration of the potential Vdata of the video signal during the video signal supply period Tdata to the time integration of the potential Vref of the reference signal during the reference signal supply period Tref becomes a product obtained by multiplying the sum of the reference signal supply period Tref and the video signal supply period Tdata by the center potential Vcenter. In this embodiment, since Vdata and Vref are not changed during the periods where the time integration is performed respectively and hence, it is sufficient that the following formula A1 is satisfied.

Vcenter=(Tref×Vref+Tdata×Vdata)/(Tref+Tdata) (A1)

Due to such a condition, the change of the gate potential of the drive transistor Q1 based on the video signal Vdata in the video signal supply period Tdata and the change of the gate potential of the drive transistor Q1 based on the reference signal Vref during the reference signal (compensation signal) supply period Tref arranged adjacent to the video signal supply period Tdata cancel each other. As a result, even when the gray level of the pixel is changed by being influenced by the video signal Vdata during the video signal supply period Tdata, the gray level of the pixel is changed in the reverse direction by being influenced by the reference signal during the preceding reference signal supply period Tref and hence, the change of the brightness averaged with time can be suppressed whereby the smear can be decreased. Further, not only a state where Vdata is higher than Vref but also a state where Vdata is lower than Vref are used in a current control of the drive transistor Q1. Accordingly, a maximum potential of Vdata necessary for allowing the flow of the same electric current in the organic EL element LM can be decreased thus realizing the reduction of the power consumption. Further, the reference signal which becomes the reference can be also variably inputted in the same manner as the video signal and hence, the gray level which is substantially equal to the gray level of the conventional pixel can be expressed with input amplitude smaller than the conventional amplitude.

Even when the above-mentioned formula is not satisfied, by setting such that Vref is lowered during the video signal supply period Tdata, it is possible to acquire the substantially same advantageous effect although the degree of the advantageous effect differs to some extent. For example, instead of satisfying the above-mentioned relationship, Vdata and Vref may satisfy the condition that an arithmetic average of Vref and Vdata is fixed, that is, Vref and Vdata satisfy the following formula A2. Here, Vcenter indicates a fixed potential.

Vcenter=(Vref+Vdata)/2 (A2)

Hereinafter, the constitution of the drive signal generating part SG for generating the above-mentioned drive signal is explained. FIG. 7 is a block diagram showing one constitution of the drive signal generating part SG. FIG. 7 shows the block constitution of parts which generate a drive signal Vo corresponding to one column of pixels in the drive signal generating part SG. The constitution is formed of a video signal conversion processing part IU, a reference signal conversion processing part RU, and a selection part CU. The video signal conversion processing part IU receives gray level data DT acquired by the latch circuit LT and generates the video signal Vdata. The reference signal conversion processing part RU receives the gray level data DT acquired by the latch circuit LT and generates the reference signal Vref. The video signal Vdata and the reference signal Vref are preliminarily set for every gray level which the gray level data DT indicates such that light having gray level which the gray level data DT indicates is emitted from the organic EL element and the above-mentioned condition is satisfied. To cope with other factors such as a factor that the difference between the video signal Vdata and the reference signal Vref is not always proportional to the gray level to be displayed, these set values may be set empirically. The selection part CU receives the video signal Vdata and the reference signal Vref, selects one of the video signal Vdata and the reference signal Vref during the above-mentioned period, and outputs the selected signal as the drive signal Vo.

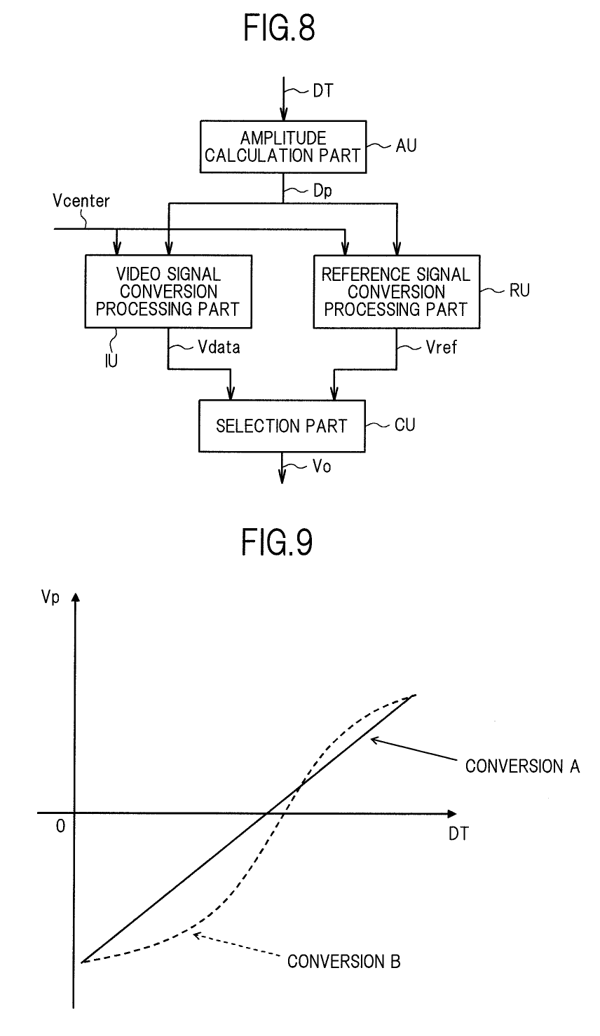

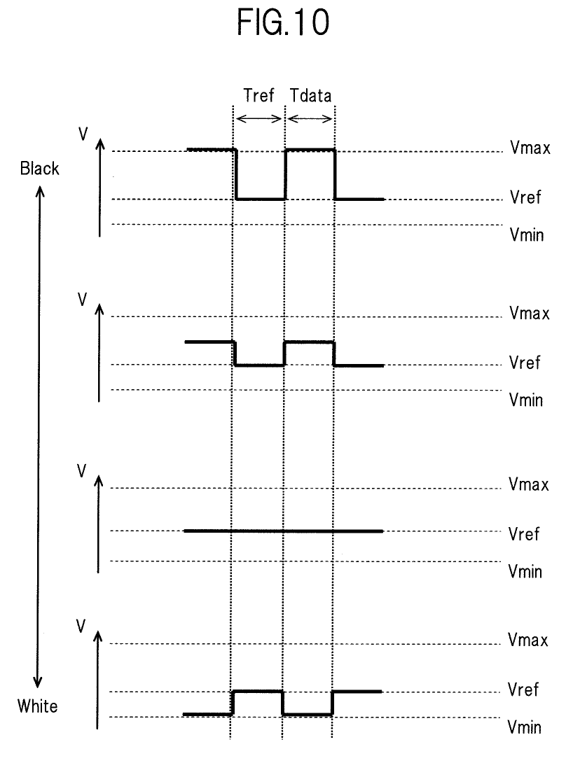

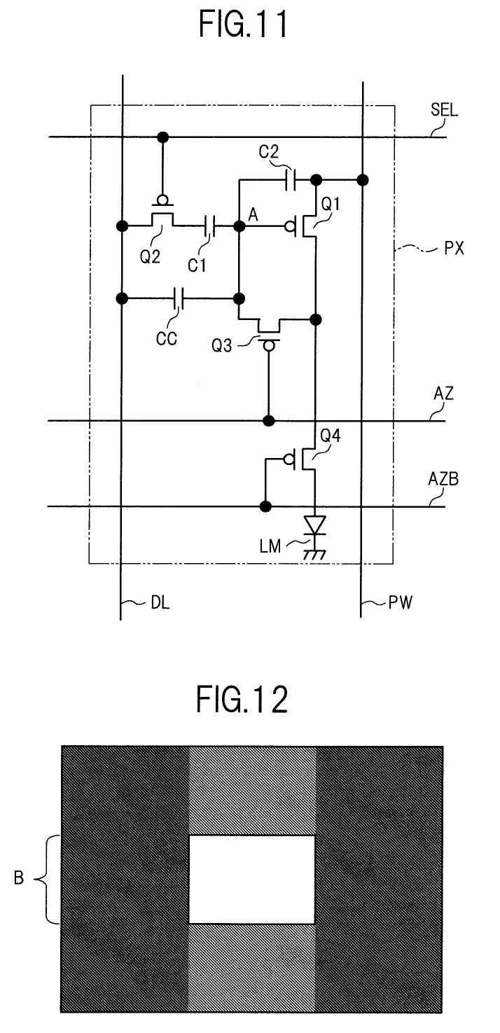

The constitution of the drive signal generating part SG is not limited to the above-mentioned constitution. For example, the light emission intensity of the organic EL element is determined based on a change quantity from the reference signal Vref to the video signal Vdata and hence, the video signal Vdata and the reference signal Vref may be decided after obtaining the change quantity firstly. FIG. 8 is a block diagram showing another constitution of the drive signal generating part SG. In the same manner as FIG. 7, FIG. 8 shows the block constitution of parts which generate the drive signal Vo corresponding to one column of pixels in the drive signal generating part SG. The constitution is formed of an amplitude calculation part AU, a video signal conversion processing part IU, a reference signal conversion processing part RU and the selection part CU.

The amplitude calculation part AU receives the gray level data DT acquired by the latch circuit LT, and calculates a value obtained by dividing a value indicative of an amount of change from Vref to Vdata by 2 as change quantity data Dₚ. FIG. 9 is a graph showing the relationship between the gray level data DT and the change quantity data Dp. Gray level indicated by the gray level data DT and a change quantity indicated by change quantity data Dp may have the linear functional relationship as indicated by conversion A, or may have the curved relationship by taking the characteristics of the organic EL element into consideration as indicated by conversion B.

The video signal conversion processing part IU receives the change quantity data Dp and the center potential Vcenter, and generates the video signal Vdata. The reference signal conversion processing part RU receives the change quantity data Dp and the center potential Vcenter, and generates the reference signal Vref. Here, assuming the change quantity indicated by change quantity data Dp as Vp, since 2Vp=Vdata−Vref, the video signal Vdata and the reference signal Vref are generated so as to satisfy this formula and formula A1. To be more specific, the video signal Vdata and the reference signal Vref are set so as to satisfy the following formulae.

Vdata=Vcenter+α×Vp (B1)

Vref=Vcenter−(2−α)×Vp (B2)

Here, α=(2×Tref)/(Tref+Tdata)

These formulae are established when the time integration of the potential of the drive signal is fixed. α=1 is established when the arithmetic average of the video signal Vdata and the reference signal Vref is fixed.

The selection part CU receives the video signal Vdata and the reference signal Vref, and selects one of the video signal Vdata and the reference signal Vref in response to the above-mentioned period, and outputs the selected signal as the drive signal Vo.

While there have been described what are at present considered to be certain embodiments of the invention, it will be understood that various modifications may be made thereto, and it is intended that the appended claims cover all such modifications as fall within the true spirit and scope of the invention.

For example, the period during which the time integration is performed is not limited to the time during which the reference signal Vref and the video signal Vdata are supplied to the pixel circuit PX on a certain row. This is because by setting the period during which the time integration is performed is set to 1 frame, by performing the time integration of potential of the video signal Vdata during the period in which the video signal Vdata is supplied in 1 frame, and also by lowering the potential of the compensation signal during 1 frame along with the elevation of the potential of the video signal Vdata, it is possible to acquire the substantially equal advantageous effects.

Further, the destination to which the present invention is applicable is not limited to the image display device which performs the so-called auto-zero operation using the reference signal. Also in this case, by supplying the potential of the video signal in a usual method and, thereafter, by supplying the signal having the potential of Vref which is calculated using the formula A1 and the formula A2 during the period in which the video signal is not written in the pixel circuit, it is possible to acquire the substantially equal advantageous effects. Besides the image display device which uses the organic EL elements, the present invention is also applicable to an image display device which uses current-control-type light emitting elements. Further, the present invention is also applicable to a liquid crystal display device. This is because although the liquid crystal display device does not include light emitting elements, the gray level of the pixel displayed by the capacitive coupling and the video signal is changed.

What is claimed is:

1. An image display device comprising:
signal lines;
an acquisition means which acquires gray level information;
a video signal generating means which generates a video signal based on the gray level information;
a compensation signal generating means which generates a compensation signal based on the gray level information;
a selecting means which alternately supplies the video signal and the compensation signal to the signal lines; and
a plurality of pixel circuits; wherein
each of the pixel circuits is connected to the signal line,
the plurality of pixel circuits store the potential difference corresponding to the video signal sequentially, and display gray level corresponding to the stored potential difference, and
the compensation signal generating means generates the compensation signal based on the gray level information such that the larger the time integration of the potential of the video signal during a period in which the video signal is supplied is, the smaller the time integration of the potential of the compensation signal during a period in which the compensation signal is supplied is.

2. The image display device according to claim 1, wherein the compensation signal generating means generates the compensation signal based on the gray level information such that the larger the potential of the video signal during a period in which the video signal is supplied to one of the plurality of pixel circuits is, the smaller the potential of the compensation signal during a period in which the compensation signal is supplied to one of the plurality of pixel circuits is.

3. The image display device according to claim 1, wherein each of the pixel circuits further includes a light emitting element which changes brightness in response to a quantity of an electric current, and the light emitting element emits light having gray level corresponding to the potential difference stored in each of the pixel circuits.

4. The image display device according to claim 3, wherein each of the pixel circuits further comprises:
a drive transistor which adjusts the quantity of electric current supplied to the light emitting element;
a pixel switch which fetches a potential corresponding to the video signal or the compensation signal; and
a storage capacitive element which stores a voltage which is obtained by adding a voltage corresponding to the potential difference between the video signal and the compensation signal to a threshold voltage of the drive transistor, and controls the quantity of electric current which drive transistor supplies based on the stored voltage.

5. The image display device according to claim 4, wherein each of the pixel circuits further comprises:
an auto zero switch which is arranged between a gate electrode and a drain electrode of the drive transistor;
a lighting control switch which is arranged between one end of the light emitting element and the drain electrode of the drive transistor; and
a cancel capacitive element which is arranged between one end of the pixel switch and the gate electrode of the drive transistor, wherein
a power source potential is supplied to a source electrode of the drive transistor,
a predetermined reference potential is supplied to another end of the light emitting element,
one end of the storage capacitive element is connected to the source electrode of the drive transistor,
the other end of the storage capacitive element is connected to the gate electrode of the drive transistor, and
the other end of the pixel switch is connected to the signal line.

6. The image display device according to claim 1, wherein the compensation signal generating means generates the compensation signal based on the gray level information such that a sum of the time integration of the potential of the video signal during a period in which the video signal is supplied and the time integration of the potential of the compensation signal during a period in which the compensation signal is supplied becomes equal to a product obtained by multiplying a sum of the period in which the video signal is supplied and the period in which the compensation signal is supplied by the predetermined potential.

7. The image display device according to claim 1, wherein the compensation signal generating means generates the compensation signal based on the gray level information such that an average of the potential of the video signal and the potential of the compensation signal becomes equal to a predetermined potential.
